(19) United States
(12) Patent Application Publication
(10) Pub. No.: US 2024/0151333 A1
(43) Pub. Date: May 9, 2024

(54) CONNECTING STRUCTURE OF VAPOR CHAMBER AND HEAT PIPE

(71) Applicant: JWS TECHNOLOGY CO., LTD., New Taipei City (TW)

(72) Inventors: Pang-Hung LIAO, New Taipei City (TW); Chih-Wei CHEN, New Taipei City (TW)

(21) Appl. No.: 17/983,749

(22) Filed: Nov. 9, 2022

(51) Int. Cl. F16L 21/00; F28F 1/00; F28F 3/02; F28F 21/08

(52) U.S. Cl. CPC F16L 21/00; F28F 1/00; F28F 3/02; F28F 21/081; F28F 2280/02

(57) ABSTRACT

A connecting structure includes a vapor chamber, a heat pipe and a working fluid. The vapor chamber includes a half shell seat, a half shell cover and a first wick structure. The half shell cover is sealed with the half shell seat and a chamber is defined therebetween. The half shell cover has a through hole and an annular wall. The first wick structure is laid on an inner surface of the half shell cover and extended into the annular wall. The heat pipe includes a tube body and a second wick structure. The tube body has an opening and a flange. The heat pipe is upright connected to an outer periphery of the annular wall by the opening. The flange is closely attached to an outer surface of the half shell cover. The second wick structure contacts the first wick structure. The working fluid is disposed in the chamber.

### BACKGROUND

### Technical Field

The disclosure relates to a cooler technology, particularly to a connecting structure of a vapor camber and a heat pipe.

### Description of Related Art

With the increase of the booting speed of computers and the reading speed of software, the heat and temperature of the working electronic components also continuously rise. High temperature not only ages most electronic components rapidly, but also slows down the writing and reading speed of part of electronic components. Thus, how to keep the working temperature at reasonable range is the research issue of the disclosure.

To solve the above cooling problem of electronic components, the industry has developed high-performance cooling and heat transfer devices, such as heat pipes and vapor chambers. Such cooling and heat transfer devices possess thermal conductivity ability with low weight and high performance, so they gradually become a mainstream cooler of electronic components.

However, during the manufacture process, a large number of molds are needed for machining such as punching, cutting and folding, and the arrangement of wick structure is an important factor relating to its capillary adsorption. In the structure of a related-art vapor chamber and heat pipe, leakage of the working fluid frequently occurs at its junction position because of rise of the internal temperature and pressure. Also, the wick structure is a non-continuous structure, so its capillary adsorption may not meet the requirement. In addition, the manufacture process of such vapor chamber and heat pipe is considerably cumbersome and complicated. As a result, it cannot satisfy the using requirements at the present time.

In view of this, the inventors have devoted themselves to the above-mentioned related art, researched intensively and cooperated with the application of science to try to solve the above-mentioned problems. Finally, the invention which is reasonable and effective to overcome the above drawbacks is provided.

### SUMMARY

An object of the disclosure is to provide a connecting structure of a vapor camber and a heat pipe, which is easy to be made, has low costs and makes the vapor chamber and the heat pipe be closely connected to improve the cooling performance and the service life.

To accomplish the above object, the disclosure provides a connecting structure, which includes a vapor chamber, at least one heat pipe and a working fluid. The vapor chamber includes a half shell seat, a half shell cover and a first wick structure. The half shell cover is closely sealed with the half shell seat correspondingly and a chamber is defined therebetween. The half shell cover is disposed with a through hole and an annular wall extended from a periphery of the through hole. The first wick structure is laid on an inner surface of the half shell cover and extended into the annular wall. The heat pipe includes a tube body and a second wick structure laid in the tube body. The tube body has an opening and a flange formed on a periphery of the opening. The heat pipe is upright connected to an outer periphery of the annular wall by the opening. The flange is closely attached to an outer surface of the half shell cover. The second wick structure contacts the first wick structure. The working fluid is disposed in the chamber of the vapor chamber.

The disclosure further has the following functions. The half shell cover and the first wick structure, the tube body and the second wick structure, and the half shell seat and the third wick structure may be individually manufactured for assembling and connecting. The arrangement of projecting section makes the second wick structure be sandwiched between the tube body and the projecting section, that makes positioning during assembling become easy and the liquid working fluid rapidly flow back during working. The arrangement of U-shaped heat pipe may release heat generated from heat sources at different areas by mutual communication. The disclosure may also save the costs of making molds and reduce the inventory management costs.

### BRIEF DESCRIPTION OF THE DRAWINGS

FIG. 1 is an exploded view of the half shell cover and the first wick structure of the disclosure;

FIG. 2 is an exploded view of the vapor chamber of the disclosure;

FIG. 3 is an exploded view of the vapor chamber and each heat pipe of the disclosure;

FIG. 4 is an exploded cross-sectional view of the vapor chamber and the heat pipe of the disclosure;

FIG. 5 is a partially enlarged view of FIG. 4;

FIG. 6 is an assembled cross-sectional view of the vapor chamber and the heat pipe of the disclosure;

FIG. 7 is a partially enlarged view of FIG. 6; and

FIG. 8 is an assembled view of the connecting structure of the vapor chamber and each heat pipe of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

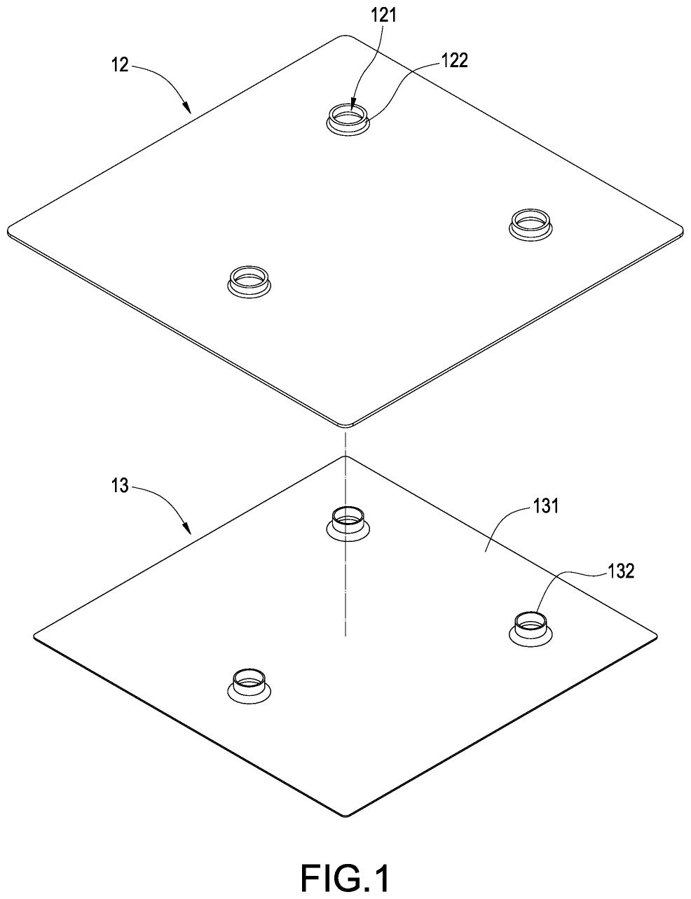

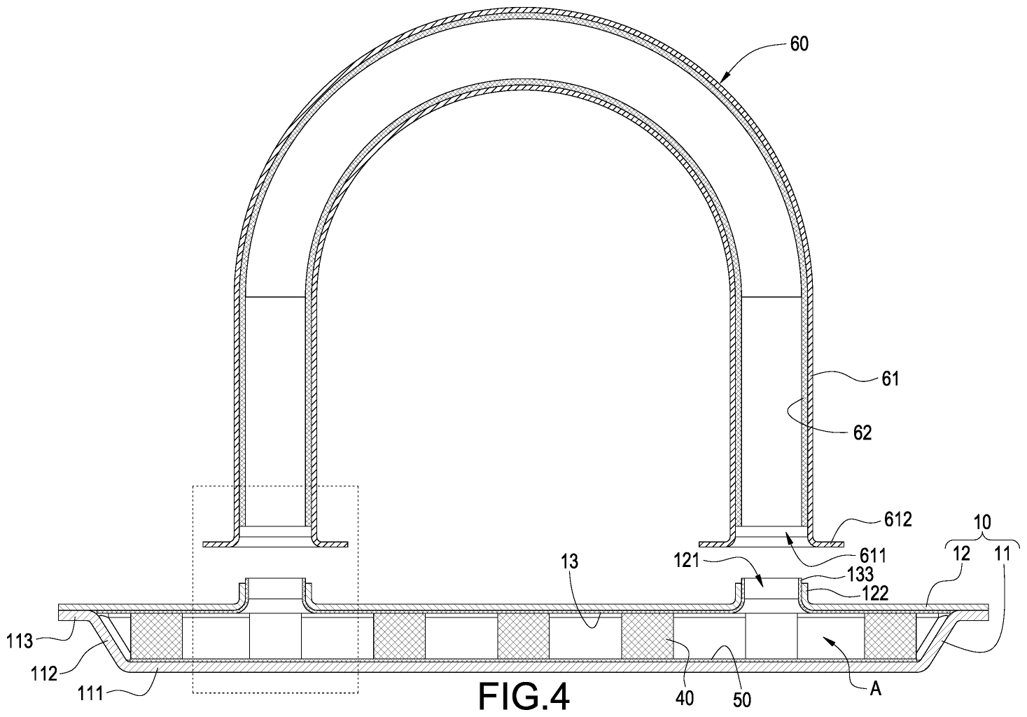

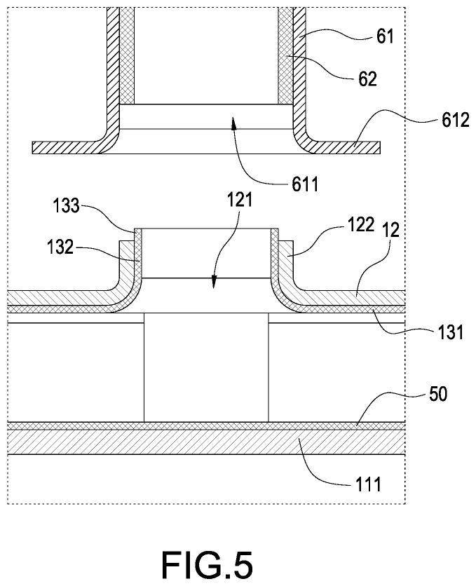

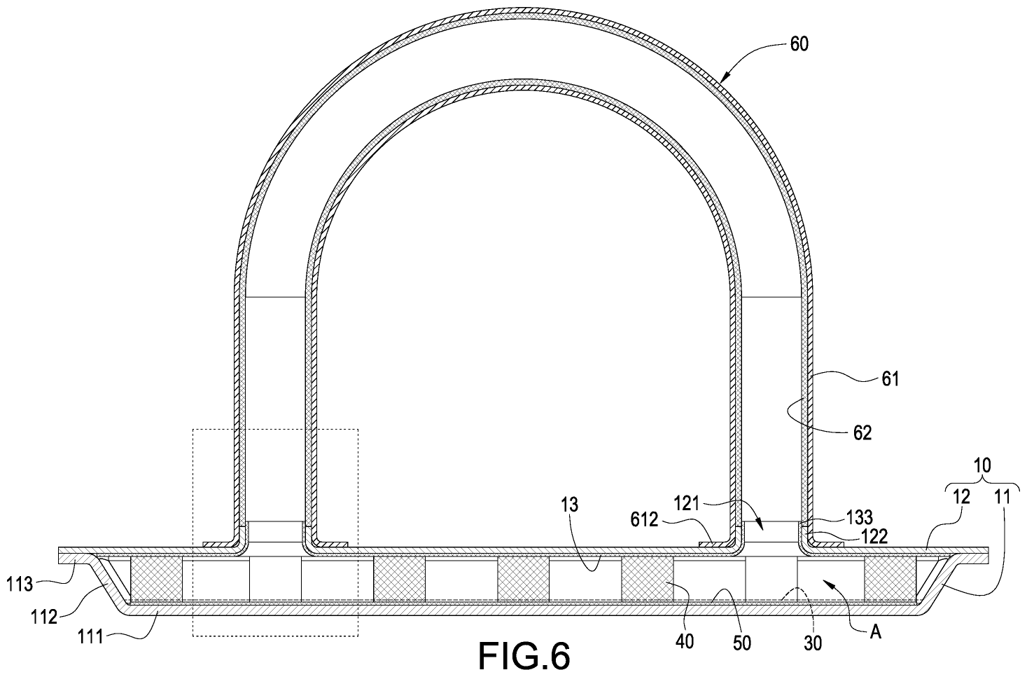

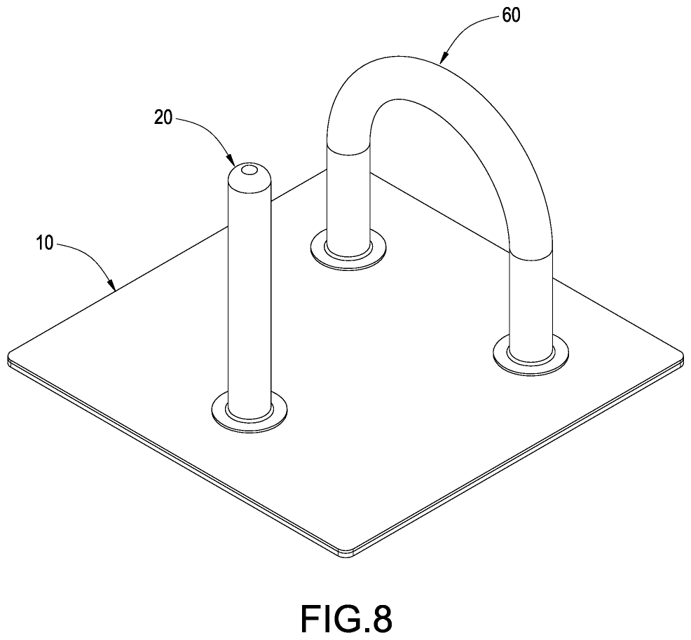

Please refer to FIGS. 1-8. The disclosure provides a connecting structure of a vapor camber and a heat pipe, which includes a vapor chamber 10, at least one heat pipe 20 and a working fluid 30.

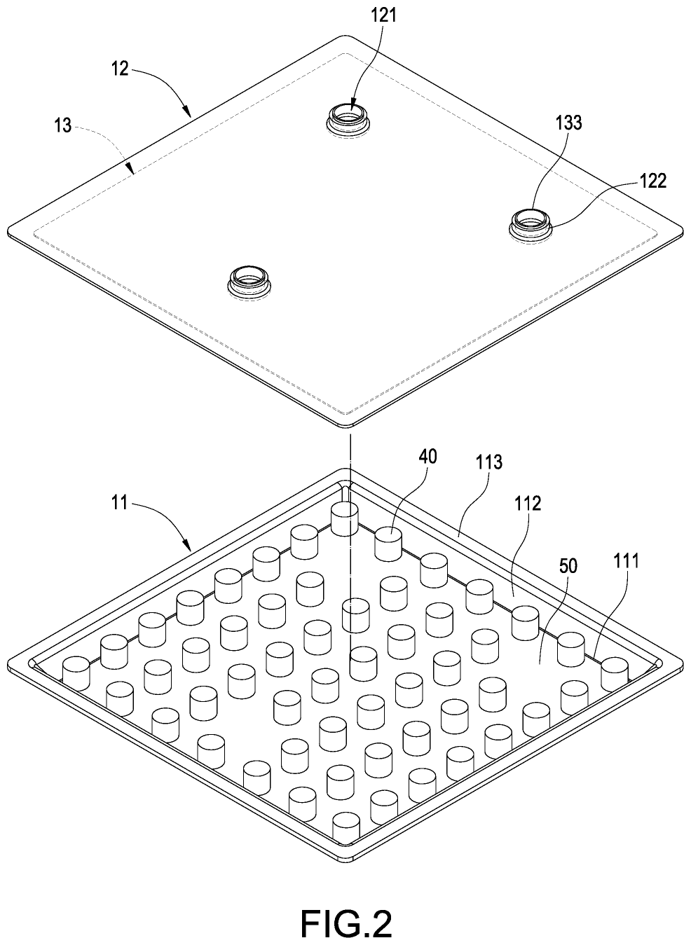

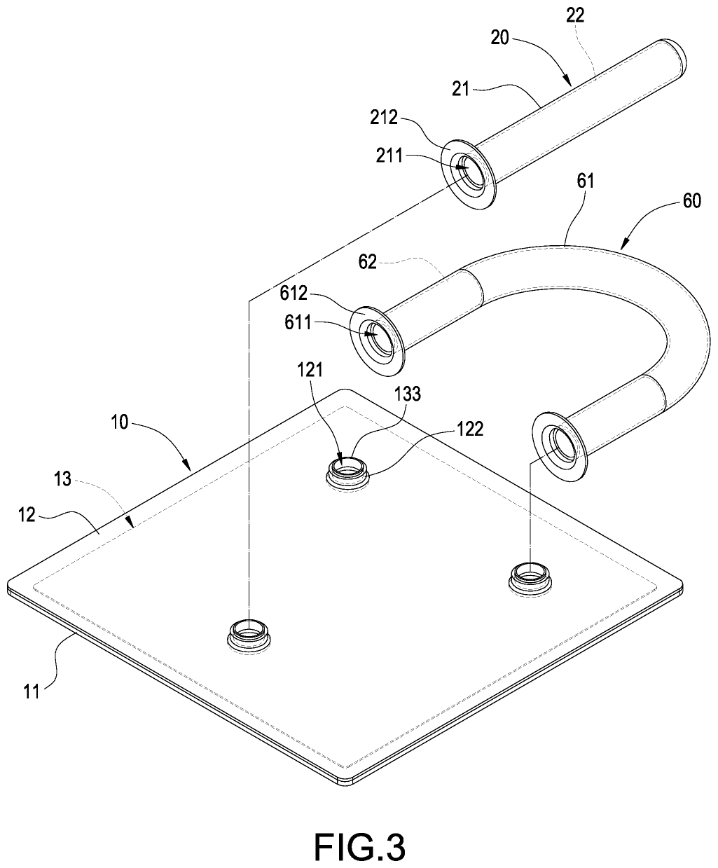

Please refer to FIGS. 2 and 3. The vapor chamber 10 includes a half shell seat 11, a half shell cover 12 and a first wick structure 13. The half shell seat 11 is made of a material with desirable thermal conductivity such as copper, aluminum, magnesium or an alloy thereof and includes a bottom plate 111 and a surrounding plate 112 upward extended from a periphery of the bottom plate 111. An end of the surrounding plate 112 away from the bottom plate 111 is extended with a flange 113.

Please also refer to FIG. 1. The half shell cover 12 is also made of a material with desirable thermal conductivity such as copper, aluminum, magnesium or an alloy thereof. In the embodiment, the half shell cover 12 is a flat plate and closely sealed with the half shell seat 11 correspondingly and a chamber A is formed between the half shell seat 11 and the half shell cover 12. The half shell cover 12 is disposed with three through holes 121 at intervals. A periphery of each through hole 121 is upward extended with an annular wall 122. The amounts of the through holes 121 and the annular walls 122 may be different depending on actual using requirements.

The first wick structure 13 may be made of a material with desirable adsorption ability such as metal woven mesh, porous sintered powder structure or fiber bundles. When the first wick structure 13 is metal woven mesh, after the metal woven mesh has been produced according to each specification, it is assembled with the half shell cover 12. When first wick structure 13 is a porous sintered powder structure, metal powder is laid on an inner surface of the half shell cover 12 and an inner surface of each annular wall 122 by a tool and the metal powder is fixed on the half shell cover 12 and each annular wall 122 by sintering process.

In detail, the first wick structure 13 of the embodiment includes a sheet body 131. The sheet body 131 is formed with multiple hollow rods 132 respectively corresponding to the through holes 121. The sheet body 131 is attached to an inner surface of the half shell cover 12. Each hollow rod 132 passes through each through hole 121 and each annular wall 122 and forms a projecting section 133 over the top of each annular wall 122.

Please refer to FIGS. 3-8. The heat pipe 20 includes a tube body 21 and a second wick structure 22. The tube body 21 is made of a material with desirable thermal conductivity such as copper, aluminum, magnesium or an alloy thereof. An end of the tube body 21 has an opening 211 and a flange 212 formed on a periphery of the opening 211. The second wick structure 22 may be made of a material with desirable adsorption ability such as metal woven mesh, porous sintered powder structure or fiber bundles and is laid on an inner surface of the tube body 21.

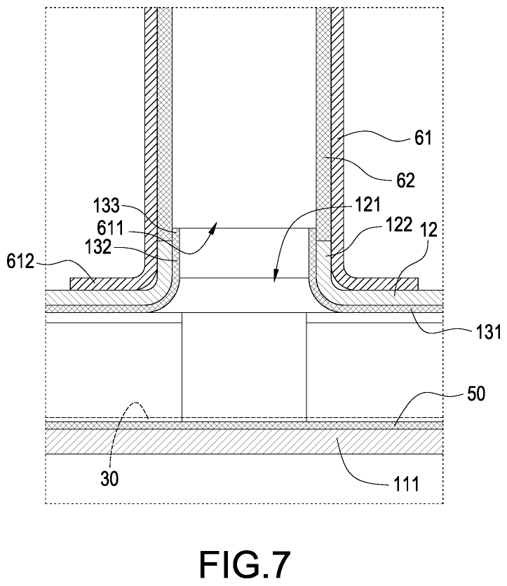

The heat pipe 20 is upright connected to an outer periphery of the annular wall 122 by the opening 211. The flange 212 is closely attached to an outer surface of the half shell cover 12. The second wick structure 22 contacts the first wick structure 13 to be connected in a lap joint manner as shown in FIG. 7. That is, a part area of the second wick structure 22 is embedded between the inner surface of the tube body 21 and the projecting section 133.

The working fluid 30 may be pure water which fills in the chamber A, and the chamber A and the inside of the tube body 21 form a vacuum chamber through a degassing and sealing process.

In an embodiment, the connecting structure of vapor camber and heat pipe of the disclosure further includes multiple support rods 40. The support rod 40 may be a porous sintered powder structure. Two end faces of each support rod 40 separately abut against the bottom plate 111 and the first wick structure 13.

In an embodiment, the connecting structure of vapor camber and heat pipe of the disclosure further includes a third wick structure 50 laid on the bottom plate 111. Two end faces of each support rod 40 separately abut against the third wick structure 50 and the first wick structure 13.

In an embodiment, the connecting structure of vapor camber and heat pipe of the disclosure further includes another heat pipe 60 upright disposed on the half shell cover 12. The heat pipe 60 includes a U-shaped tube body 61 and a fourth wick structure 62. The U-shaped tube body 61 is made of a material with desirable thermal conductivity such as copper, aluminum, magnesium or an alloy thereof. Two ends of the U-shaped tube body 61 separately have an opening 611 and a flange 612 formed on the opening 611. The fourth wick structure 62 may be made of a material with desirable adsorption ability such as metal woven mesh, porous sintered powder structure or fiber bundles and is laid on an inner surface of the U-shaped tube body 61. Each opening 611 is separately upright connected to an outer periphery of each annular wall 122. Each flange 612 is closely attached to an outer surface of the half shell cover 12.

While this disclosure has been described by means of specific embodiments, numerous modifications and variations could be made thereto by those skilled in the art without departing from the scope and spirit of this disclosure set forth in the claims.

What is claimed is:

1. A connecting structure, comprising:
a vapor chamber, comprising a half shell seat, a half shell cover and a first wick structure, wherein the half shell cover is sealed with the half shell seat correspondingly and a chamber is defined therebetween, the half shell cover comprises a through hole and an annular wall extended from a periphery of the through hole, and the first wick structure is disposed on an inner surface of the half shell cover and extended into the annular wall;
at least one heat pipe, comprising a tube body and a second wick structure disposed in the tube body, the tube body comprising an opening and a flange disposed on a periphery of the opening, wherein the heat pipe is upright connected to an outer periphery of the annular wall by the opening, the flange is attached to an outer surface of the half shell cover, and the second wick structure is in contact with the first wick structure; and
a working fluid, disposed in the chamber of the vapor chamber.

2. The connecting structure of claim 1, wherein the second wick structure is in contact with the first wick structure in a lap joint manner.

3. The connecting structure of claim 1, wherein the first wick structure comprises a sheet body, the sheet body comprises a hollow rod disposed corresponding to the through hole, the sheet body is attached on the inner surface of the half shell cover, the hollow rod passes through the through hole and the annular wall and comprises a projecting section over a top of the annular wall.

4. The connecting structure of claim 3, wherein a part area of the second wick structure is embedded between an inner surface of the tube body and the projecting section.

5. The connecting structure of claim 1, wherein the first wick structure and the second wick structure are a metal woven mesh, a porous sintered powder structure or a fiber bundle, respectively.

6. The connecting structure of claim 1, further comprising multiple support rods, wherein two end faces of each support rod separately abut against an inner surface of the half shell seat and the first wick structure.

7. The connecting structure of claim 1, further comprising multiple support rods and a third wick structure disposed on an inner surface of the half shell seat, wherein two end faces of each support rod separately abut against the third wick structure and the first wick structure.

8. The connecting structure of claim 7, wherein each support rod is a porous sintered powder structure.

9. The connecting structure of claim 1, further comprising another heat pipe upright disposed on the half shell cover.

10. The connecting structure of claim 9, wherein the through hole and the annular wall are multiple in number, the another heat pipe comprises a U-shaped tube body and a fourth wick structure disposed in the U-shaped tube body, the U-shaped tube body comprises an opening and a flange on each end thereof, the flange is disposed on a periphery of the opening, the another heat pipe is upright connected to the outer periphery of each annular wall by each opening, each flange is attached to the outer surface of the half shell cover, and the fourth wick structure is in contact with the first wick structure.
